(19) United States
(12) Patent Application Publication
(10) Pub. No.: US 2026/0162853 A1
(43) Pub. Date: Jun. 11, 2026

(54) ELECTRICAL LEAD-THROUGH AND LEAD-THROUGH ASSEMBLY

(71) Applicant: SCHOTT AG, Mainz (DE)

(72) Inventor: Thomas BÜCHER, Ergolding (DE)

(73) Assignee: SCHOTT AG, Mainz (DE)

(21) Appl. No.: 18/722,761

(22) PCT Filed: Dec. 14, 2022
(86) PCT No.: PCT/EP2022/085902

§ 371 Date: Jun. 21, 2024

(30) Foreign Application Priority Data
Jan. 13, 2022 (DE) 10 2022 100 729.4

(51) Int. Cl. H01B 17/30; G21C 17/116; H01B 3/12; H01B 3/30

(52) U.S. Cl. CPC H01B 17/30; G21C 17/116; H01B 3/12; H01B 3/30

(57) ABSTRACT

An electrical lead-through is provided with a main body having a through-opening with an electrical conductor fixed therein by an insulator which closes the through-opening. The insulator includes a leakage path extension which surrounds, at a spacing, a part of the electrical conductor that protrudes beyond the holding portion, wherein the leakage path extension is integral with the holding portion or is materially bonded to the holding portion. The main body surrounds and contacts the leakage path extension at least in part. Further aspects of the invention relate to a lead-through assembly including such a lead-through, and to the use of the electrical lead-through.

The invention relates to an electrical lead-through comprising a main body having at least one through-opening, wherein at least one electrical conductor is arranged in the through-opening and is fixed in the through-opening by at least one insulator, wherein the insulator closes the through-opening and seals with respect to the conductor and a wall of the through-opening. Further aspects of the invention relate to a lead-through assembly comprising such a lead-through and the use of the electrical lead-through.

Electrical lead-throughs with a glass or glass-ceramic component penetrated by electrical conductors, which in turn is enclosed in a metal main body, are used in numerous applications. These applications include equipment in the deep sea, such as oil drilling and exploration equipment, or their use in chemically or radiation contaminated environments, such as in the chemical industry or in energy plant and reactor technology. Other applications also include manned and unmanned watercraft, such as submersibles and submarines, as well as special gas tanks, such as CO₂ storage tanks or H₂ tanks for motor vehicles having fuel cells, and aerospace applications.

In underwater applications, such as oil production, high temperatures, high pressures and/or corrosive media can place particular demands on electrical lead-throughs, especially when taking into account service lives of around 20 years. In applications such as storage tanks, where media such as liquid gas or liquid hydrogen are used, extremely low temperatures can occur to which the electrical lead-throughs are exposed. In reactor applications in the field of civil nuclear power, such as high-temperature reactors, electrical lead-throughs sometimes have to withstand extremely high pressures, temperatures and/or radiation, especially over lifetimes of around 40 to 60 years. High pressures, temperatures and/or radiation also place special demands on electrical lead-throughs in small modular reactors (SMRs).

For electrical lead-throughs, additional insulating components can be arranged between the main body and the electrical conductor, in particular to provide a leakage path extension. Such leakage path extensions can ensure permanent insulation between the electrical conductor and the main body even if, for example, adverse ambient conditions can lead to the accumulation of dirt or the formation of water films. However, known leakage path extensions made of plastics lack resistance to ageing and high temperatures in particular.

It is also known from DE102014218983 A1 to arrange an additional protective element made of glass or plastic adjacent to the glass holding the electrical conductor. However, such measures can only achieve a comparatively short leakage path extension.

Against this background, it is an object of the invention to provide electrical lead-throughs which are resistant to continuous operation under difficult environmental conditions, in particular high pressures, high or low temperatures, corrosive media and/or radiation exposure, and which have an extended leakage path compared to the known lead-throughs.

### DISCLOSURE OF THE INVENTION

An electrical lead-through is proposed which comprises a main body having at least one through-opening, wherein at least one electrical conductor is arranged in the through-opening and is fixed in the through-opening by at least one insulator, wherein the insulator closes the through-opening and seals with respect to the electrical conductor and a wall of the through-opening.

Furthermore, it is provided that the insulator has at least one holding portion which seals with respect to the at least one electrical conductor and holds same, and that the insulator has at least one leakage path extension which surrounds, at a distance, a part of the electrical conductor projecting beyond the holding portion, wherein the at least one leakage path extension is formed in one piece with the at least one holding portion or is connected in an integrally bonded manner to the at least one holding portion, in particular by glass soldering or adhesive bonding, and the main body at least partially surrounds the at least one leakage path extension. The main body contacts the leakage path extension and thereby supports it.

The electrical lead-through can comprise exactly one electrical conductor or can comprise several electrical conductors, for example three, four or five, wherein in this case each electrical conductor is preferably guided in its own lead-through-opening.

The insulator comprises a holding portion, which contacts the electrical conductor and holds same, and at least one leakage path extension. The at least one leakage path extension preferably projects at least 5 mm, particularly preferably at least 10 mm and very particularly preferably at least 20 mm beyond the holding portion at which the insulator contacts the electrical conductor. p Significantly larger leakage paths can also be realized, with the leakage path extension preferably projecting at least 50 mm, particularly preferably at least 100 mm or even at least 200 mm beyond the holding portion. The leakage path extension of the insulator surrounds the electrical conductor at a distance and therefore does not contact it.

The leakage path extension made of insulating material extends the leakage path between the electrical conductor and the main body, thus increasing the operational safety of the electrical lead-through. If an inorganic material is selected, this leakage path extension is particularly resistant to ageing and can also be designed to be temperature-resistant. Alternatively, an organic material can also be selected for the leakage path extension. This simplifies production so that the leakage path extension can be arranged with little effort.

There is a gap between the leakage path extension and the electrical conductor, which defines a space in which a plug can be pushed onto the electrical conductor for electrical contacting. In the case of a cylindrical electrical conductor and a hollow cylindrical shape of the leakage path extension, a cylindrical gap is formed accordingly. The size of the gap can be selected in such a way that sufficient space remains for such a connector. For example, the size of the gap can be selected in the range from 3 mm to 5 mm.

The insulator with the holding portion and the at least one leakage path extension can consist of a single component or be composed of several components.

If the insulator is designed as a single component, the insulator can be designed as a tube, for example. In this case, a holding portion can be designed as a region of the tube with a reduced inner diameter. Alternatively or additionally, the electrical conductor may have an enlarged diameter in the region of the holding portion. In this case, it is possible for a tubular insulator to have a constant inner diameter and only contact the electrical conductor where it has an enlarged diameter. Alternatively, the tubular insulator can have a reduced diameter in the region of the holding portion and the diameter of the electrical conductor can be constant in the region of the holding portion or only widen to a lesser extent. The region of the tubular insulator that contacts the electrical conductor is the holding portion. The parts of the tubular insulator that protrude beyond this holding portion represent the leakage path extensions.

In a multi-part design of the insulator, the holding portion is preferably formed by a first component with a through-opening which contacts the electrical conductor. This first component can be designed as a disk, for example, which is arranged inside a tubular second component and connected to it. The parts of the second component that protrude beyond the disk then represent the leakage path extensions. Alternatively, a disk-shaped first component can be combined with one or more tubular second components, wherein the disk-shaped first component is connected to the mouths of the tubular second components. The tubular second components then represent the leakage path extensions.

If several components are used to form the insulator, they are preferably integrally bonded together to ensure a permanent and tight connection between the individual components. If at least one of the components consists of a glass or a glass ceramic, it is preferable that this component is vitrified to the other component by means of heat treatment. If both components are made of glass or glass-ceramic, they can also be fused together by heat treatment and form an intimate bond. If the leakage path extension is made of an organic material that cannot be vitrified, adhesive bonding is preferred for an integrally bonded connection. In particular, a potting compound can be used for this purpose, which connects to one another in an integrally bonded manner the individual components that form the insulator.

The use of a tubular component for the leakage path extension allows comparatively large leakage path extensions to be produced in a simple manner, which can also have lengths of significantly more than 20 mm.

A wall thickness of the leakage path extension of the insulator is preferably selected in such a way that it has sufficient mechanical stability but takes up as little space as possible. For high mechanical stability, it is preferred that the wall thickness of the leakage path extension is at least 0.1 mm, more preferably at least 0.2 mm, particularly preferably at least 0.5 mm, very particularly preferably at least 1.0 mm and most preferably at least 1.5 mm. In order to take up as little space as possible, it is preferable to select a wall thickness of less than 5 mm, particularly preferably less than 2.5 mm and most preferably less than 2 mm.

The leakage path extension can be cylindrical, in particular in the form of a circular cylinder. Of course, other cross-sectional shapes are also conceivable. In one embodiment, the inner diameter of the leakage path extension can be constant over the entire length. Alternatively, the inner diameter can vary. Conical designs of the leakage path extensions are preferred, so that the inside of the leakage path extension widens conically starting from the holding portion of the insulator.

The diameter of the electrical conductor is selected in particular depending on the required dielectric strength. The diameter of the electrical conductor can be 6 mm, for example.

Preferably, the main body has a lead-through portion with a first diameter, wherein the at least one holding portion is located within the lead-through portion. Furthermore, the main body preferably has extension portions on one or both sides of the lead-through portion, which have a smaller second diameter and at least partially surround the leakage path extension. Alternatively, the extension portion can also be designed with the same diameter as the lead-through portion or even have a larger diameter.

Further components can be arranged on the lead-through portion. For example, it is possible to arrange connecting means with which the electrical lead-through can be connected to other components such as a housing or a mounting flange.

Preferably, the main body completely surrounds the at least one leakage path extension. In particular, an extension portion with corresponding dimensions can be provided for this purpose, through which the main body is extended in the axial direction. It is preferable if the leakage path extension is in direct contact with the main body over its entire length, so that there is no gap between the main body and the leakage path extension. Advantageously, the main body can thus protect the insulator from mechanical damage. The main body can also serve as a support, in particular for the leakage path extensions of the insulator, so that these can be designed with thinner walls. It is preferable that the main body contacts the entire outer surface of the leakage path extension and thus supports it. Alternatively, it is also conceivable that the main body only partially surrounds the leakage path extension, wherein in this case extension portions can also be provided on the main body.

The leakage path extension can be flush with the main body or an extension portion of the main body. Alternatively, the main body can protrude beyond the leakage path extension. Preferably, a protrusion created in this way is at least 1 mm, particularly preferably 2 mm, more preferably at least 5 mm, even more preferably 10 mm and most preferably at least 20 mm. The length of the protrusion should preferably be less than 50 mm, particularly preferably 20 mm, more preferably 10 mm, even more preferably 5 mm and most preferably no more than 2 mm.

In the region of the protrusion, the inner diameter of the passage opening can be enlarged to create a step. The leakage path extension is then preferably flush with this step.

The inner diameter of the through-opening of the main body can be reduced in the region of the lead-through portion compared to an inner diameter in an adjacent extension portion. It is preferable that a transition between such a passage portion with a reduced diameter and an extension portion with a larger diameter takes place continuously in a transition region.

Preferably, a first end and/or a second end of the electrical conductor are surrounded by one or more leakage path extensions. This provides protection against contact, among other things. Furthermore, it is possible to design the leakage path extension in such a way that it also partially or completely surrounds a plug pushed onto the electrical conductor. In this case, the lead-through also protects a plug connection from environmental influences and, in particular, from mechanical damage.

Preferably, the electrical lead-through comprises at least two insulators, which are separated from each other by a cavity and/or at least one separating element and both seal with respect to the same electrical conductor. In this way, an electrical conductor is sealed multiple times in a lead-through-opening and the reliability of the lead-through is increased, as in the event of an insulator fault, the at least one other insulator can seal the lead-through-opening tightly. For example, two insulators are used for each electrical conductor to form a so-called double lead-through.

The separating element can, for example, have a ring shape or a disk shape and completely or partially fill the space between the electrical conductor and an inner wall of the opening. Suitable materials for the separating element include, in particular, ceramics and glass-ceramics. An example of a suitable separating element is a thin ceramic disk with an opening for the electrical conductor. The thickness of the ceramic disk can be less than 1 mm, for example. Of course, thicker separating elements can also be used, especially if they are to fill a space between the two insulators.

Preferably, the at least one through-opening in the electrical lead-through is hermetically sealed by the at least one insulator.

Hermetic tightness is understood in particular to mean that, at a pressure difference of 1 bar, the helium leakage rate is preferably <1·10⁻⁷ mbar Is⁻¹, particularly preferably <1·10⁻⁸ mbar Is⁻¹ and most preferably <1·10⁻⁹ mbar Is⁻¹.

The insulator is hermetically sealed both with respect to the electrical conductor and with respect to the inner wall of the opening.

In a variant of the invention, the material of the at least one leakage path extension is preferably selected from an organic material, in particular from a thermoplastic material. An example of a suitable plastic is polytetrafluoroethylene (PTFE).

An adhesive bond is preferably used to connect the organic leakage path extension to the holding portion in an integrally bonded manner, wherein a potting compound is preferably used for this purpose. Suitable potting compounds include, in particular, silicone-based potting compounds.

If the at least one leakage path extension is obtained from an organic material, it is preferably fixed via a thread in addition to the potting material. For example, an external thread can be arranged on the leakage path extension and a corresponding internal thread can be arranged in the through-hole of the main body.

Preferably, the holding portion and the leakage path extension each consist of an inorganic insulating material, wherein the materials for the holding portion and the leakage path extension can be selected differently or identically.

Preferably, the material of the holding portion and/or the leakage path extension is selected from a glass, a glass-ceramic or a ceramic or the inorganic insulation material comprises at least one glass, a glass-ceramic or a ceramic.

If the insulator is composed of several components, the materials used are preferably selected in such a way that the coefficients of thermal expansion of the individual components are matched to each other. Preferably, a thermal expansion coefficient of the leakage path extension deviates by less than 20%, preferably less than 10%, from the thermal expansion coefficient of the at least one holding portion when different materials are selected.

Preferably, the insulator or a component of the insulator, which represents or contains the holding portion, is obtained by sintering a glass compact or a ceramic compact. It is preferred that the pressed part is brought together with the component serving as the leakage path extension before a temperature treatment for sintering, so that an integral bond with the leakage path extension is also obtained during sintering. For this purpose, the glass compact can be inserted together with the electrical conductor into a leakage path extension designed as a tube or arranged adjacent to one or more tubes serving as leakage path extensions.

The at least one leakage path extension is preferably in the form of a glass tube. Suitable materials for the glass tube include in particular soda-lime glass and alkaline earth (barium) silicate glasses, which are available from SCHOTT AG under the glass numbers 8421 and 8061.

Soda-lime glass, which is available from SCHOTT AG in the form of AR glass tubing, for example, is particularly suitable. For example, glass tubes with a wall thickness of 1.2 mm are suitable for use as a leakage path extension of the insulator.

In addition to the leakage path extension, the holding portion of the insulator can also be in the form of a glass tube or made from a glass tube. For example, in a temperature treatment step at a temperature above the glass transition temperature, part of the material of the glass tube can be shaped so that it forms the holding portion. In such a temperature treatment step, forming tools can be used in particular, which are removed again after the temperature treatment.

In order to achieve a particularly good seal between the metal parts, i.e. the main body and the at least one electrical conductor, and the at least one insulator, the lead-through can be designed in the form of a pressurized glass lining. A thermal expansion coefficient of the main body is selected to be greater than a thermal expansion coefficient of the insulator, so that after a temperature treatment in which the insulator is vitrified in the lead-through-opening, the main body contracts more than the insulator. This results in permanent compressive forces being exerted on the insulator by the main body.

Accordingly, it is preferred that a coefficient of thermal expansion of the main body is greater than a coefficient of thermal expansion of the at least one insulator. It is particularly preferable for the coefficient of thermal expansion of the main body to be at least 20% greater than the coefficient of thermal expansion of the insulator in the case of pressure glazing.

As an alternative to pressure glazing, however, it is also possible to match the thermal expansion coefficients of the main body and insulator to one another, wherein a difference in the thermal expansion coefficients of less than 20% is preferred for matching and a difference of less than 10% is particularly preferred.

The forces generated by the pressure glazing also strengthen the material of the insulator, especially if a glass is selected that is prestressed by the compressive forces. This increases the mechanical stability both in the region of the holding portion and in the region of the at least one leakage path extension. This is particularly advantageous in the event of temperature fluctuations, as the prestressing prevents the occurrence of undesirable tensile stresses that could cause the glass to break. Furthermore, the improved mechanical stability offers advantages when connectors have to be mounted on or removed from the electrical conductor.

The material of the main body is preferably selected from a metal. The metal is particularly preferably steel.

Suitable materials for the at least one electrical conductor include metals, in particular nickel-iron alloys, cobalt-iron alloys, steels, in particular Kovar, aluminum, copper or a combination of several of these materials. An example of a combination is a copper conductor arranged in a nickel-iron tube.

In order to increase the pressure on the leakage path extension, particularly at its end pointing away from the holding portion, an end sleeve can be arranged at each end of the leakage path extension. This can connect laterally to the end of the leakage path extension and/or support the leakage path extension from the inside. The end sleeve exerts pressure on the leakage path extension so that it is not only pressurized from the outside by the extension portion of the main body, but also from the inside and/or from the side and is therefore pre-stressed. This advantageously increases the stability of the leakage path extension, especially if it is made of an inorganic material such as glass, glass ceramic or ceramic.

In particular, the same materials that are suitable for the main body can be selected as the material for the end sleeve.

Several of the electrical lead-throughs described herein, each comprising a main body, can be accommodated in a common lead-through assembly. Such a lead-through assembly comprises a base with several through-openings and an electrical lead-through arranged therein.

The base can be part of an apparatus or the housing of an apparatus.

Alternatively or additionally, several lead-throughs can be combined in a lead-through assembly, which have a common main body. This common main body then comprises a passage opening for each of the lead-throughs.

The invention further relates to the use of an electrical lead-through or an assembly comprising a plurality of such lead-throughs, in particular as described above, in an application with pressures of at least 5 bar, preferably of at least 10 bar, particularly preferably of at least 20 bar and/or in an application with temperatures of at least −273° C., preferably of at least 300° C., particularly preferably of at least 600° C. and/or in an application with a γ-radiation exposure of at least 1 kGy, preferably of at least 1 MGy, particularly preferably of at least 20 MGy, wherein the specified values of the γ-radiation exposure are to be understood in particular over the entire operating time of the electrical lead-through.

The invention further relates to the use of an electrical lead-through or an assembly comprising a plurality of such lead-throughs, in particular as described above, for equipment in the deep sea, such as in an oil and/or gas drilling or exploration device, and/or in chemically or radiation contaminated environments, such as in the chemical industry or in energy plant and reactor technology, in particular in potentially explosive atmospheres, in an energy generation or energy storage device with an enclosure, or in an encapsulation of an energy generation device or an energy storage device or a reactor or a storage device of toxic and/or harmful matter, in particular as a lead-through device within the containment of a reactor or lead-through device through the containment of a reactor, in particular of a chemical or nuclear reactor, or in a space vehicle or space exploration vehicle, or in a housing of a sensor and/or actuator, in or on manned and unmanned water vehicles, for example diving robots and submarines as well as gas tanks, in particular CO₂ storage tanks or H₂ tanks, preferably also for motor vehicles having fuel cells.

Lastly, the invention relates to a method for producing an electrical lead-through, in particular as described herein. In the method, a main body with at least one through-opening is provided. Subsequently, an insulator is provided together with an electrical conductor and inserted into the through-opening. Subsequently, a temperature treatment is carried out in which the insulator is glass soldered or melted to an inner wall of the through-hole and to the electrical conductor.

During this temperature treatment or in a separate step, the insulator can be assembled from one or more pre-components, wherein the pre-components used are bonded together. For this purpose, these are heated above their glass overhang temperature, i.e. to a temperature above 800° C. in the case of conventional glasses, so that the materials of the pre-components mix and an intimate integral bond is formed.

For example, an insulator can be obtained from a glass tube and a compact, wherein the compact comprises glass and/or ceramic powder. During heat treatment, the compact is sintered and integrally bonded to the glass tube. It may be intended to exert a force on the glass tube in the direction of the compact so that it partially sinks into the compact, thus creating an enlarged region in which the materials of the compact and glass tube mix. This results in a particularly intimate and stable integral bond.

In another example, in addition to the leakage path extension, the holding portion of the insulator can also be in the form of a glass tube or made from a glass tube. For example, in a temperature treatment step at a temperature above the glass transition temperature, part of the material of the glass tube can be shaped so that it forms the holding portion.

In the temperature treatment steps described for forming the insulator and/or for connecting the insulator to the main body, forming tools can be used in particular. These can be used in particular to define the gap between the inner wall of the leakage path extension and the electrical conductor. After the temperature treatment, these forming tools are removed again. A conical design of the leakage path extension, in which the inner diameter widens starting from the holding portion, can make it easier to remove the forming tools. Furthermore, it is preferable to round off a transition between a leakage path extension and the holding portion of the insulator in order to avoid a sudden change in diameter.

When producing a lead-through with an insulator consisting entirely or partially of a glass ceramic, the temperature treatment can include a further step in which a ceramizable glass of the insulator or a component of the insulator is converted into a glass ceramic. This further step can be carried out at a different temperature than the step of glass soldering or melting and/or the integral bonding of several components of the insulator.

The invention will be described in greater detail below with reference to the figures and without limitation thereto.

The figures show:

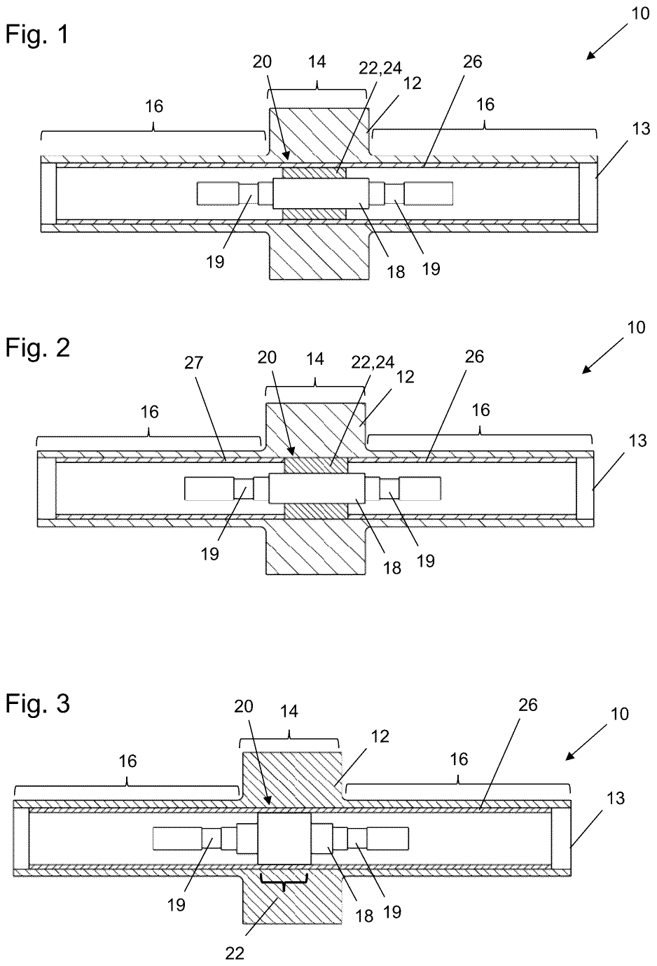

FIG. 1: a schematic sectional view of a first exemplary embodiment of the lead-through from the side,

FIG. 2: a schematic sectional view of a second exemplary embodiment of the lead-through from the side,

FIG. 3: a schematic sectional view of a third exemplary embodiment of the lead-through from the side,

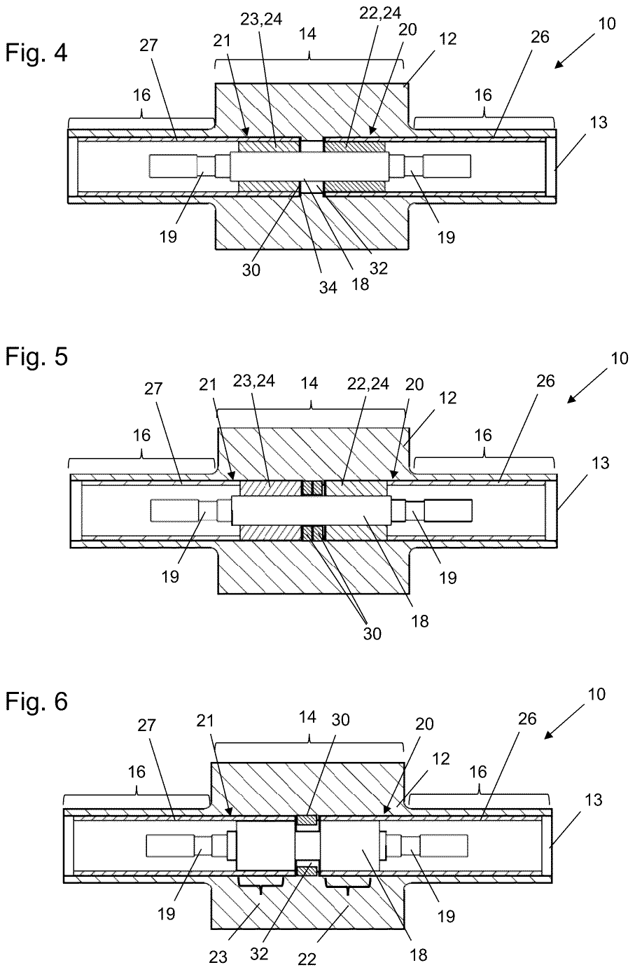

FIG. 4: a schematic sectional view of a fourth exemplary embodiment of the lead-through from the side,

FIG. 5: a schematic sectional view of a fifth exemplary embodiment of the lead-through from the side,

FIG. 6: a schematic sectional view of a sixth exemplary embodiment of the lead-through from the side,

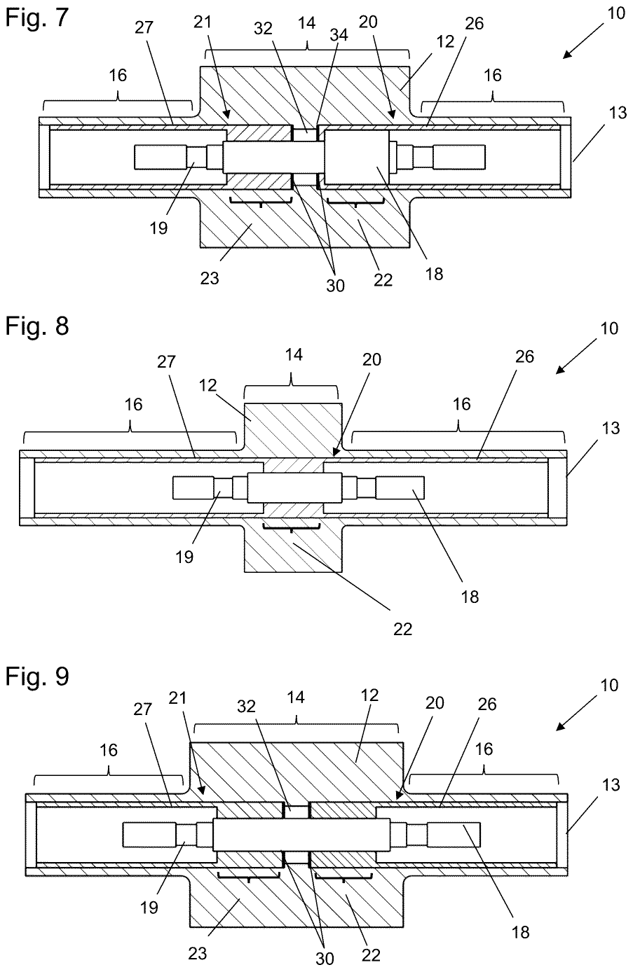

FIG. 7: a schematic sectional view of a seventh exemplary embodiment of the lead-through from the side,

FIG. 8: a schematic sectional view of an eighth exemplary embodiment of the lead-through from the side,

FIG. 9: a schematic sectional view of a ninth exemplary embodiment of the lead-through from the side,

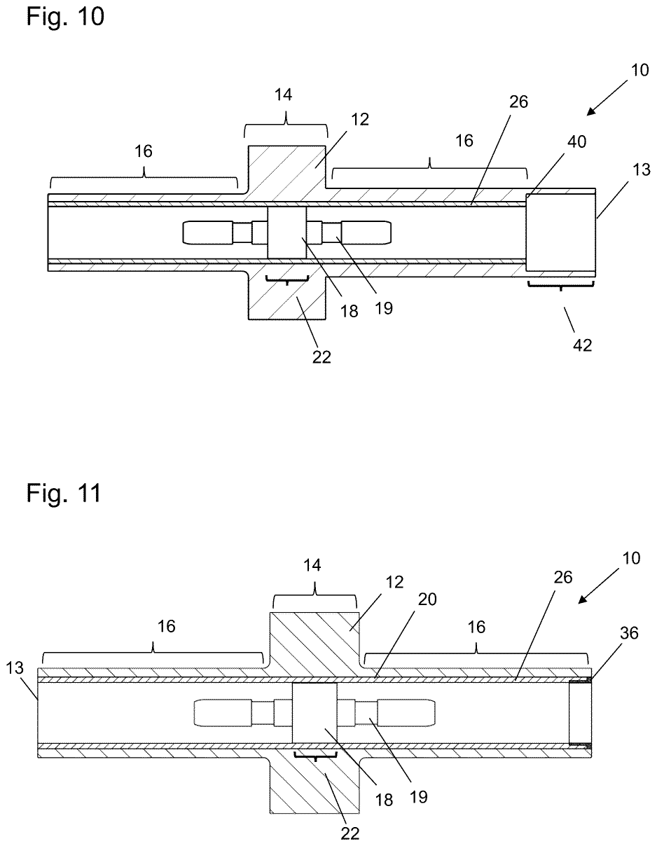

FIG. 10: a schematic sectional view of a tenth exemplary embodiment of the lead-through from the side,

FIG. 11: a schematic sectional view of the eleventh exemplary embodiment of the lead-through from the side,

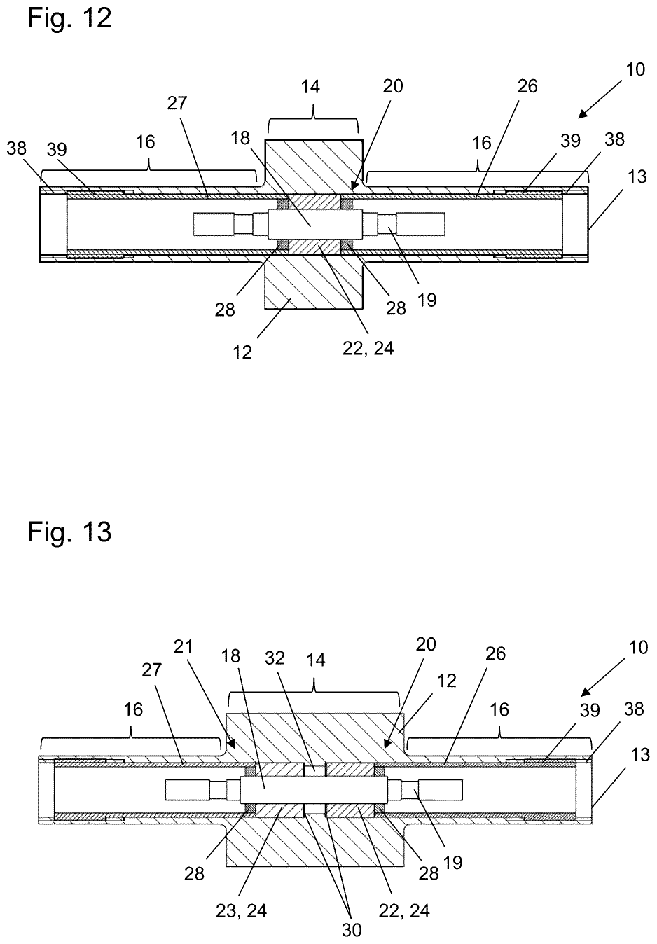

FIG. 12: a twelfth exemplary embodiment of the lead-through in a schematic sectional view from the side,

FIG. 13: a thirteenth exemplary embodiment of the lead-through in a schematic sectional view from the side,

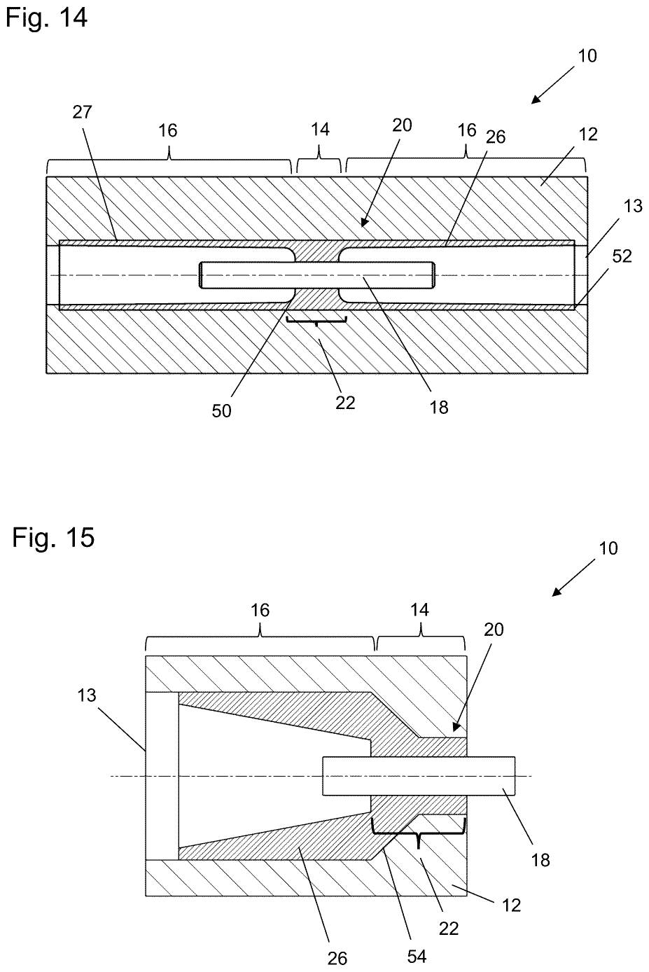

FIG. 14: a schematic sectional view of a 14th exemplary embodiment of the lead-through from the side,

FIG. 15: a schematic sectional view of an exemplary embodiment of the lead-through with one-sided assembly of the leakage path extension from the side,

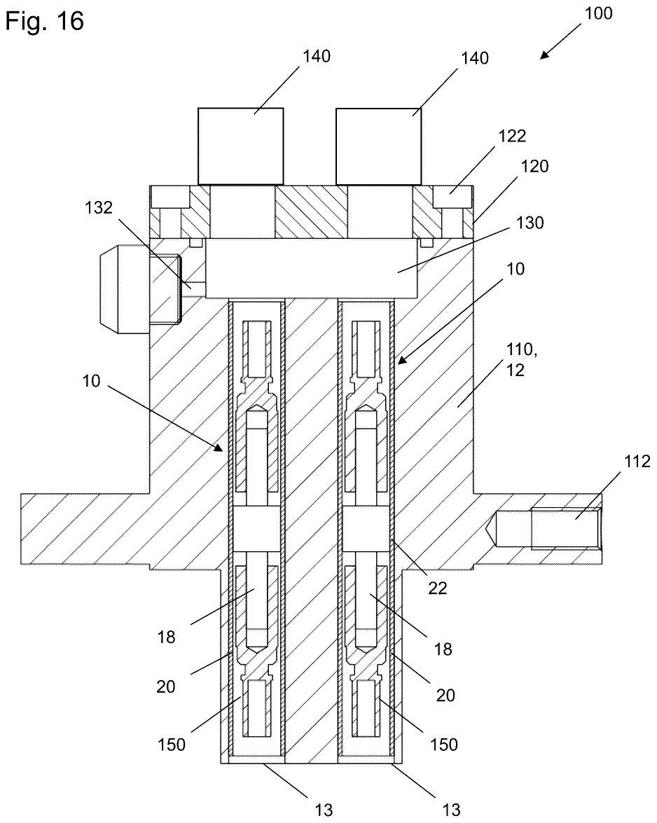

FIG. 16: a first example of a lead-through assembly comprising several electrical lead-throughs, and

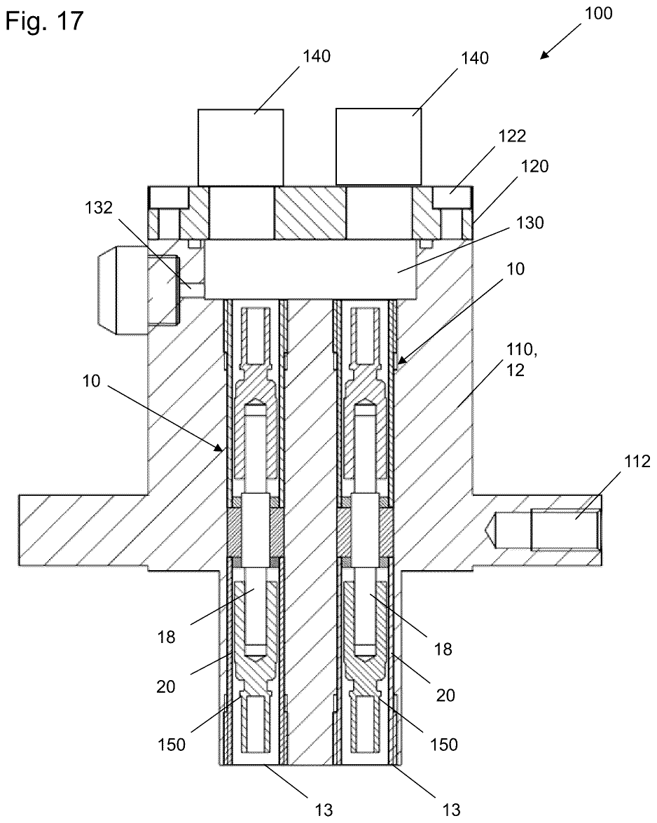

FIG. 17: a second example of a lead-through assembly comprising several electrical lead-throughs.

FIG. 1 shows a first exemplary embodiment for an electrical lead-through 10. The lead-through 10 comprises a main body 12 with a through-opening 13. An electrical conductor 18 is inserted into the through-opening 13. In the exemplary embodiment shown in FIG. 1, the electrical conductor 18 is significantly shorter than the length of the main body 10, so that it is located completely inside the through-opening 13.

The electrical conductor 18 is held in the lead-through-opening 13 via an insulator 20, wherein the insulator 20 fixes the electrical conductor 18 in the lead-through 10 and insulates it electrically from the main body 12. For this purpose, the insulator 20 has a holding portion 22, which is arranged within a lead-through portion 14 of the main body 12 and seals with respect to the electrical conductor 18. The insulator 20 further comprises a leakage path extension 26, which is tubular in shape and surrounds the electrical conductor 18, but does not contact it, so that there is a distance between the electrical conductor 18 and the leakage path extension 26. The leakage path extension 26 projects beyond the ends of the electrical conductor 18 and is in turn surrounded over its entire length by extension portions 16 of the main body 12, wherein the extension portions 16 in the example shown do not end flush with the leakage path extension 26, but project beyond it. In the region of the extension portions 16, which adjoin the lead-through portion 14 on both sides, the main body 12 has a second diameter that is smaller than a first diameter of the lead-through portion 14. The insulator 20 with the leakage path extension 26 seals hermetically with respect to the inner wall of the through-opening 13, so that the through-opening 13 is closed by the insulator 20 and the electrical conductor 18.

In the example shown in FIG. 1, the leakage path extension 26 is designed as a single glass tube, wherein the holding portion 22 of the insulator 20 is formed by a sintered glass compact 24, which is integrally bonded to the glass tube. Accordingly, in this example, both the leakage path extension 26 and the material forming the holding portion 22 are inorganic. This allows the insulator 20 to be particularly resistant to temperature and ageing.

In the illustrated exemplary embodiment, the electrical conductor 18 has an enlarged diameter in its center, where it is held by the glass compact 24. In other embodiments, the electrical conductor 18 can be designed with a constant diameter, for example. Furthermore, the electrical conductor 18, as shown in FIG. 1, comprises connection portions 19 with a reduced diameter near its ends, which, for example, allow a plug connector (not shown) to engage.

In the exemplary embodiment shown, the two ends of the electrical conductor 18 are located completely inside the main body 12, so that the connection portions 19 formed on the electrical conductor 18 and any plugs or connections with current conductors (not shown) connected to these are mechanically protected by the main body 12 of the lead-through 10.

FIG. 2 shows a second exemplary embodiment for an electrical lead-through 10. As already described with reference to the first exemplary embodiment of FIG. 1, the lead-through 10 comprises a main body 12 with a through-opening 13, into which an electrical conductor 18 is inserted.

The electrical conductor 18 is held in the through-opening 13 via an insulator 20 and is electrically insulated from the main body 12 by this insulator. Similar to the first exemplary embodiment, the insulator 20 has a holding portion 22, which is formed by a sintered glass compact 24. The glass compact 24 is arranged within a lead-through portion 14 of the main body 12 and seals with respect to the electrical conductor 18. In contrast to the first exemplary embodiment, the glass compact 24 also seals hermetically with respect to an inner wall of the through-opening 13, so that the through-opening is sealed tightly by the glass compact 24 of the insulator 20.

The insulator 20 shown in FIG. 2 comprises two leakage path extensions 26, 27 which are tubular in shape and surround the electrical conductor 18 at a distance so that it is not contacted. The leakage path extensions 26, 27 protrude beyond the ends of the electrical conductor 18 and are in turn surrounded over their entire length by extension portions 16 of the main body 12, wherein the extension portions 16 in the example shown do not end flush with the leakage path extensions 26, 27, but protrude beyond them. In the region of the extension portions 16, which adjoin the lead-through portion 14 on both sides, the main body 12 has a second diameter that is smaller than a first diameter of the lead-through portion 14. The leakage path extensions 26, 27 also seal with respect to the inner wall of the passage opening 13.

The two leakage path extensions 26, 27 are each formed by a tube that is integrally bonded to the glass compact 24. For this purpose, the mouths of the tubes each meet an end face of the disk-shaped glass compact 24 and are fused to it.

FIG. 3 shows a third exemplary embodiment for an electrical lead-through 10. As already described with reference to the first exemplary embodiment of FIG. 1, the lead-through 10 comprises a main body 12 with a through-opening 13, into which an electrical conductor 18 is inserted.

The electrical conductor 18 is held in the through-opening 13 by an insulator 20, which insulates it electrically from the main body 12. The insulator 20 has a holding portion 22 at which the insulator 20 contacts the electrical conductor 18 and seals with respect to it. The insulator 20 also seals with respect to an inner wall of the through-opening 13, so that this is closed by the insulator 20.

In contrast to the exemplary embodiments of FIGS. 1 and 2, the insulator 20 of the third exemplary embodiment is formed in one piece and consists of a single tube made of an inorganic insulating material such as a glass. The electrical conductor 18 has an enlarged diameter in the region of the holding portion 22, so that the electrical conductor 18 only contacts the insulator 20 within this holding portion 22. Alternatively, it would also be conceivable to reduce the inner diameter of the tubular insulator 20 within the holding portion 22.

FIG. 4 shows a fourth exemplary embodiment for an electrical lead-through 10. The lead-through 10 is designed as a double lead-through and comprises two insulators 20, 21, which are each designed similarly to the first exemplary embodiment described with reference to FIG. 1. The two insulators 20, 21 each surround the same electrical conductor 18 and are inserted together with the electrical conductor 18 in a through-opening 13 of a main body 12.

Each of the two insulators 20, 21 has a holding portion 22 or 23 at which this insulator 20, 21 contacts the electrical conductor 18 and seals with respect to it. Furthermore, each of the two insulators 20, 21 has a leakage path extension 26, 27, each of which consists of a tube made of an inorganic insulating material and projects beyond the holding portion 22, 23 on one side. The leakage path extensions 26, 27 do not contact the electrical conductor 18, so that a gap remains between the electrical conductor and the tubular part of the insulator 20, 21. Furthermore, similar to embodiments 1 to 3, the leakage path extensions 26, 27 are each surrounded by extension portions 16 of the main body 12.

In the exemplary embodiment in FIG. 4, the holding portions 22, 23 are each formed by a disk-shaped glass compact 24, wherein the electrical conductor 19 is passed through-openings in the glass compacts 24, and wherein the tubes used to extend the leakage path surround the glass compact 24. The glass compact 24 and the tube are connected to each other by an integral bond, for example by melting or glass soldering.

A cavity 32 is arranged between the two insulators 20, 21 in the exemplary embodiment of FIG. 4, so that the insulators 20, 21 do not contact each other. For a defined alignment of the two insulators 20, 21, two shoulders 34 are provided on the inner wall of the passage opening 13 in the example shown, on each of which a separating element 30 designed as a thin ceramic disk and the insulators 20, 21 can be supported.

FIG. 5 shows a fifth exemplary embodiment for an electrical lead-through 10. Like the fourth exemplary embodiment, the lead-through 10 is designed as a double lead-through and comprises two insulators 20, 21, which are each designed similarly to the second exemplary embodiment described with reference to FIG. 2. The two insulators 20, 21 each surround the same electrical conductor 18 and are inserted together with the electrical conductor 18 in a through-opening 13 of a main body 12.

The insulators 20, 21 each comprise a disk-shaped glass compact 24 serving as a holding portion 22, 23, which contacts the electrical conductor 18 and seals with respect to it. Furthermore, the glass compact 24 also seals with respect to an inner wall of the through-opening 13. Each of the insulators 20, 21 comprises, as a leakage path extension 26, 27, a tube made of an inorganic insulating material, which is integrally bonded to one end face of the glass compact 24, for example by melting or glass soldering. The leakage path extensions 26, 27 thus each project beyond only one side of the holding portion 22, 23 and surround the electrical conductor 18 at a distance, so that a gap is formed between the electrical conductor 18 and a leakage path extension 26, 27 in each case.

In the example shown in FIG. 5, the two insulators 20, 21 are separated from each other by two inserted disk-shaped separating elements 30. Alternatively, a single separating element 30 could also be used.

FIG. 6 shows a sixth exemplary embodiment for an electrical lead-through 10. Like the fourth exemplary embodiment, the lead-through 10 is designed as a double lead-through and comprises two insulators 20, 21, which are each designed similarly to the third exemplary embodiment described with reference to FIG. 3. The two insulators 20, 21 each surround the same electrical conductor 18 and are inserted together with the electrical conductor 18 in a through-opening 13 of a main body 12.

The two insulators 20, 21 of the sixth exemplary embodiment are each tubular in shape and each contact the electrical conductor 18 only in a holding portion 22, 23. The electrical conductor 18 is designed in such a way that it has an enlarged diameter within the holding portions 22, 23. The tubular insulators 20 each seal with respect to an inner wall of the through-opening 13 and in the holding portions 22, 23 with respect to the electrical conductor 18, so that the through-opening 13 is hermetically sealed.

In the sixth exemplary embodiment, an annular separating element 32 is arranged between the two insulators 20, 21, so that an annular cavity 30 is formed between the separating element 32 and the electrical conductor 18.

FIG. 7 shows a seventh exemplary embodiment for an electrical lead-through 10. Like the sixth exemplary embodiment shown in FIG. 6, the lead-through 10 is designed as a double lead-through and comprises two insulators 20, 21, which are each made from a tube. The two insulators 20, 21 each surround the same electrical conductor 18 and are inserted together with the electrical conductor 18 in a through-opening 13 of a main body 12. For a defined alignment of the two insulators 20, 21, two shoulders 34 are provided on the inner wall of the through-opening 13 in the example shown, on which a separating element 30 designed as a thin ceramic disk and the insulators 20, 21 can be supported. A cavity 32 remains between them in this design example.

In this seventh embodiment, the two insulators 20 and 21 each have a different design, but are both made from a glass tube. It can also be seen in the illustration in FIG. 7 that the electrical conductor 18 is asymmetrical. In the region of the holding portion 22 of the insulator 20, the outer diameter of the electrical conductor 18 is enlarged, whereas in the region of a further holding portion 23 of a further insulator 21, the outer diameter is not enlarged.

As a result, the first insulator 20 has a wall thickness in the holding portion 22 that corresponds to the wall thickness of the first leakage path extension 26. The wall thickness of the further insulator 21 is increased in the further holding portion 23 compared to the wall thickness of the second leakage path extension 27.

The insulators 20, 21 shown in FIG. 7 are each obtained from glass tubing, wherein these are heated in a temperature treatment step to a temperature above the glass transition temperature of the glass used and can thus be shaped. The two insulators 20, 21 are shaped by applying force from the outside to the glass tubes in the direction of the center of the lead-through 10 and using molds arranged inside the glass tubes. In the case of insulator 20, the wall thickness of the glass tube is substantially maintained, wherein some of the glass flows past the holding portion 22 and solidifies behind it. In the case of the other insulator 21, glass material flows in the direction of the other holding portion 23, so that the wall thickness of the tube increases there. After cooling below the glass transition temperature, the mold used can be removed again. A conical design of the leakage path extensions 26, 27, in which their inner diameter increases slightly outwards from the holding portions 22, 23, can make it easier to remove the mold.

FIG. 8 shows an eighth embodiment of the lead-through 10, which, similar to the first embodiment of FIG. 1, is designed as a lead-through 10 with a single insulator 20 and a single holding portion 22. In contrast to the first embodiment, however, the holding portion 22 is not formed using a glass compact 24, see FIG. 1, but is obtained by forming a glass tube.

Similarly as described with reference to the further insulator 21 of the seventh embodiment, the insulator 20 is obtained from a glass tube, which is formed under the influence of heat and force. For example, cylindrical hollow molds can be inserted into the through-opening 13 from both sides of the lead-through 10 for forming. By heating the glass tube and applying forces to the glass tube in the direction of the center of the through-opening, glass material flows in the direction of the holding portion 22, so that the wall thickness of the tube increases there. After cooling below the glass transition temperature, the mold used can be removed again. A conical design of the leakage path extensions 26, 27, in which their inner diameter increases slightly outwards from the holding portion 22, can again make it easier to remove the mold.

FIG. 9 shows a ninth embodiment of a lead-through 10. The lead-through 10 shown in FIG. 9 is a double lead-through, which is designed similarly to the lead-through 10 described with reference to FIG. 7. In contrast to this seventh embodiment, both insulators 20, 21 are identically designed and correspond in their structure to the further insulator 21 of the seventh embodiment.

The tenth exemplary embodiment shown in FIG. 10 substantially corresponds to the lead-through 10 already described with reference to FIG. 3. The lead-through 10 shown in FIG. 10 has an insulator 20 in which both the holding portion 22 and the leakage path extension 26 are obtained from a glass tube.

To improve the protection of the insulator 20, in deviation from the third exemplary embodiment, an additional end region 42 is provided adjacent to one of the extension portions 16, which has an enlarged inner diameter compared to the adjacent extension portion 16. A step 40 is thus formed at the transition between the extension portion 16 and the end region 42, wherein the leakage path extension 26 in this example ends flush with the step 40 and thus flush with the end of the extension portion 16.

In the example shown in FIG. 10, the leakage path extension 26 is also flush with the extension portion 16 on the other side, wherein in the example of FIG. 10 no further end portion is connected to this extension portion 16. In further embodiments, however, the lead-through 10 could of course be designed symmetrically, so that end portions 42 connect to both extension portions 16.

The eleventh exemplary embodiment shown in FIG. 11 substantially corresponds to the lead-through 10 already described with reference to FIG. 3. The lead-through 10 shown in FIG. 11 again has an insulator 20, in which both the holding portion 22 and the leakage path extension 26 are obtained from a glass tube.

In deviation from the third exemplary embodiment, an additional metal end sleeve 36 is arranged to reinforce the insulator 20, which consists, for example, of a nickel-iron alloy. In the example shown in FIG. 10, the end sleeve 36 engages from the inside in the tubular leakage path extension 26 and contacts the lateral end surface of the tubular leakage path extension 26.

Pressure is exerted on the glass of the leakage path extension 26 by the end sleeve 36, so that it is pressurized and thus prestressed not only from the outside by the extension portion 16 of the main body 12 in the radial direction, but also from the inside and/or from the side, in particular in the axial direction. This advantageously increases the stability of the leakage path extension 26, particularly if it is made of an inorganic material such as glass, glass ceramic or ceramic.

In the example shown in FIG. 11, the leakage path extension 26 is flush with the extension portion 16 on the other side, wherein no further end sleeve is provided at this end of the leakage path extension 26 in the example shown in FIG. 11. In further embodiments, however, the lead-through 10 could of course be designed symmetrically, wherein end sleeves 36 are arranged on each of the two extension portions 16.

FIGS. 12 and 13 each show exemplary embodiments in which the leakage path extension 26, 27 is not made of an inorganic material, but of an organic material. The twelfth embodiment shown in FIG. 12 is similar to the second embodiment described with reference to FIG. 2 and has an insulator 20 within the main body 12 with a holding portion 22 obtained from a glass compact 24. The holding portion 22 holds the electrical conductor 18 passed through it and seals the through-opening 13.

The insulator 20 also comprises two leakage path extensions 26, 27 made of an organic material such as a thermoplastic. These are designed in the form of PTFE tubes, for example, and are arranged adjacent to the holding portion 22 and connected to it with an integral bond via a potting compound 28.

In order to further improve the retention of the leakage path extensions 26, 27 within the extension portions 16 of the main body 12, the leakage path extensions 26, 27 have an external thread 39 at their respective ends pointing away from the holding portion 22, which engages in a corresponding internal thread 38 in the extension portions 16 of the main body 12.

In the example shown in FIG. 12, the leakage path extensions 26, 27 are not flush with the end of the extension portions 16, so that the extension portions 16 protrude beyond the leakage path extensions 26, 27.

FIG. 13 shows a thirteenth exemplary embodiment of an electrical lead-through 10, which is similar to the twelfth exemplary embodiment of FIG. 12, but in contrast to it is designed as a double lead-through similar to the exemplary embodiment of FIG. 4.

FIG. 14 shows a 14th exemplary embodiment of the electrical lead-through 10 in a schematic sectional view from the side, which is similar to the eighth exemplary embodiment of FIG. 8. The lead-through 10 according to the 14th exemplary embodiment comprises a main body 12 with a through-opening 13. An electrical conductor 18 is inserted into the through-opening 13, which is held in a holding portion 22 of a single insulator 20. The insulator 20 seals the through-opening 13 with its holding portion. The holding portion 22 can be obtained, for example, by forming a glass tube or using a glass compact. In the case of a glass tube as the starting material, this is formed using heat and force. To form a glass tube, for example, cylindrical hollow molds can be inserted into the through-opening 13 from both sides of the lead-through 10. By heating the glass tube and applying forces to the glass tube in the direction of the center of the through-opening, glass material flows in the direction of the holding portion 22 so that the wall thickness of the tube increases there. Cylindrical shapes can also be used from both sides with a glass compact as the starting material, wherein the insulator 20 is obtained from the compact by the action of heat. After cooling below the glass transition temperature, the mold used can be removed again.

The leakage path extensions 26, 27 of the insulator 20 are tapered so that their inner diameter increases slightly outwards from the holding portion 22. This makes it easier to remove the mold during production. In addition, a transition between the leakage path extensions 26, 27 and the holding portion 22 of the insulator 20 is provided with rounded portions 50. Furthermore, provision is made here, by way of example, for exerting a preload on the insulator 20 in the axial direction via a step 52 on the main body 12. This axial preload is preferably exerted in addition to a compressive force acting in the radial direction and exerted on the insulator 20 by the main body 12. However, as an alternative to a step 52 in the main body, it would also be conceivable to exert a compressive force and thus a preload on the insulator 20 in the axial direction via an end sleeve 36, as shown in FIG. 11, for example.

FIG. 14 also shows that in the 14th exemplary embodiment, the extension portions 16 of the main body 12, which connect to both sides of the lead-through portion 14, have the same diameter as the lead-through portion 14.

FIG. 15 shows a schematic sectional view from the side of an exemplary embodiment of the electrical lead-through 10, in which a leakage path extension 26 is arranged on only one side starting from the lead-through portion 14 of the main body 12. Only the part of the conductor 18 to the left of the holding portion 22 in FIG. 15 is surrounded by the leakage path extension 26 at a distance. The part of the conductor 18 to the right of the holding portion 22 in FIG. 15, on the other hand, is exposed.

As in the previously described exemplary embodiments, the main body 12 of the lead-through 10 has a through-opening 13 into which the conductor 18 is inserted and is held by the holding portion 22 of the insulator 20. The holding portion 22 of the insulator 20 seals the through-opening 13.

In the exemplary embodiment of FIG. 15, the diameter of the lead-through-opening 13 is not constant over the entire length, but expands in a transition region 54 starting from a smaller diameter within the lead-through portion 14 to a larger diameter in the extension portion 16. Since the main body 12 contacts and supports the leakage path extension 26 of the insulator 20 adjacent to the holding portion 22 over its entire length, an outer diameter of the insulator 20 also increases accordingly. This design with a variable inner diameter means that a free space provided between the conductor 18 and the leakage path extension 26 for establishing an electrical connection with the conductor 18 can be designed to be as large as possible and, at the same time, a thickness of the insulator 20 in the holding portion 22 can be reduced.

FIG. 16 shows an example of a lead-through assembly 100 comprising several electrical lead-throughs 10. Two lead-throughs 10 are visible in the sectional view in FIG. 16.

The lead-through assembly 100 comprises a base 110 with several through-openings 13, into each of which an electrical lead-through 10 is inserted. In the example shown in FIG. 16, the base 110 forms a common main body 12 for all lead-throughs 10. Alternatively, the lead-throughs can each have their own main body 12, which is then hermetically sealed to the base 110, for example by welding.

The base 110 serving as the main body 12 completely encloses the insulators 20 with their leakage path extension 26, 27 (see FIGS. 1 to 6), so that the insulators 20 are protected from environmental influences and, in particular, mechanical damage. In the example shown in FIG. 16, the leakage path extension 26 and the holding portion 22 are made of an inorganic material, for example a glass tube. The insulators 20 can thus be designed to be particularly resistant to temperature and ageing. In the example shown in FIG. 16, the base 110 also comprises fastening means 112, which are designed here as a threaded hole with which the base 110 can be fastened, for example, to a component of an apparatus or a housing.

An electric current can be conducted from one side of the lead-through assembly 100 to the other side through the electrical lead-throughs 10. For this purpose, the electrical conductors 18 of the individual lead-throughs 10 can be contacted, for example using plugs 150, to which conductors, for example in the form of cables (not shown in FIG. 16), can then be connected.

In the example shown in FIG. 16, the through-openings 13 open on one side into a common cavity 130, which is formed by a recess in the base 110 and a holding plate 120 connected to the base 110. The holding plate 120 can be connected to the base 110 via fastening means 122 such as screws. If the electrical conductors 18 of the individual lead-throughs 10 are contacted via connectors 150 and cables (not shown), the cables can be routed through the cavity 130 and the holding plate 120. Cable glands 140 can then seal off the cavity 130 so that it is protected from environmental influences such as moisture. The cavity 130 can be vented, for example, via a closable vent opening 132.

FIG. 17 shows a second example of a lead-through assembly 100, which is designed similarly to the first example of FIG. 16. In contrast to the first example, the individual lead-throughs 10 are designed in accordance with the twelfth exemplary embodiment described with reference to FIG. 12. Accordingly, the insulators 20 each have a holding portion 22, which was obtained from a glass compact 24 and thus consists of an inorganic material. In contrast, the leakage path extensions 26, 27, see FIG. 12, are made of an organic material, for example a PTFE tube. These are integrally bonded to the holding portion 22 via the potting compound 28. Furthermore, the leakage path extensions 26, 27 are additionally mechanically fixed via external threads 39 arranged at their ends, which engage in corresponding internal threads 38 of the through-openings 13.

The claims are not limited to the exemplary embodiments described herein. In particular, a large number of variations are possible in which individual features of the embodiments described herein are combined with one another.

### LIST OF REFERENCE SIGNS

10 lead-through
12 main body
13 through-opening
14 lead-through portion
16 extension portion
18 electrical conductor
19 connection portion
20 insulator
21 further insulator
22 holding portion
23 further holding portion
24 compact
25 further compact
26 leakage path extension
27 further leakage path extension
28 potting compound
30 separating element
32 cavity
34 shoulder
36 end sleeve
38 internal thread
39 external thread
40 step
42 end region
50 rounded portion
52 step
54 transition region
100 lead-through assembly
110 base
112 fastening means
120 holding plate
122 fastening means
130 cavity
132 vent opening
140 cable gland
150 plug

1. An electrical lead-through comprising a main body having a through-opening, wherein an electrical conductor is arranged in the through-opening and is fixed in the through-opening by an insulator, wherein the insulator closes the through-opening and seals with respect to the conductor and a wall of the through-opening,
wherein
the insulator has a holding portion which seals with respect to the electrical conductor and holds same, and the insulator has a leakage path extension which surrounds, at a distance, a part of the electrical conductor projecting beyond the holding portion, wherein the leakage path extension is formed in one piece with the holding portion or is connected in an integrally bonded manner, to the holding portion, and the main body at least partially surrounds the leakage path extension, wherein the main body contacts the leakage path extension.

2. The electrical lead-through as claimed in claim 1, wherein the main body has a lead-through portion with a first diameter, wherein the holding portion is located within the lead-through portion, and extension portions are arranged on one or both sides of the lead-through portion, which extension portions have a smaller second diameter and at least partially surround the leakage path extension.

3. The electrical lead-through as claimed in claim 1, wherein the main body completely surrounds the leakage path extension, wherein the main body is flush with the leakage path extension (26, 27) or projects beyond the leakage path extension.

4. The electrical lead-through of claim 1, wherein a first end and/or a second end of the electrical conductor are surrounded by one or more leakage path extensions.

5. The electrical lead-through of claim 1, wherein the electrical lead-through comprises at least two insulators which are separated from each other by a cavity and/or a separating element and both seal with respect to the same electrical conductor.

6. The electrical lead-through of claim 1, wherein the through-opening is hermetically sealed by the insulator.

7. The electrical lead-through of claim 1, wherein the material of the leakage path extension is selected an inorganic material or from an organic material.

8. The electrical lead-through as claimed in claim 7, wherein the leakage path extension made of an organic material is fixed to the main body via a potting material and/or via a thread.

9. The electrical lead-through of claim 1, wherein the holding portion consists of an inorganic insulation material, wherein the materials for the holding portion and the leakage path extension are the same or different.

10. The electrical lead-through of claim 1, wherein the material of the holding portion and/or the material of the leakage path extension is selected from a glass, a glass-ceramic or a ceramic, or in that the material of the leakage path extension comprises glass, a glass-ceramic or a ceramic.

11. The electrical lead-through as claimed in claim 9, wherein, with different material selection, a thermal expansion coefficient of the leakage path extension deviates by less than 20%, from the thermal expansion coefficient of the holding portion.

12. The electrical lead-through of claim 9, wherein the holding portion is obtained by sintering a glass compact or ceramic compact.

13. The electrical lead-through of claim 9, wherein the leakage path extension is in the form of a glass tube.

14. The electrical lead-through of claim 1, wherein a coefficient of thermal expansion of the main body is greater than a coefficient of thermal expansion of the insulator.

15. The electrical lead-through of claim 1, wherein the material of the main body is a metal.

16. The electrical lead-through of claim 1, wherein the material of the electrical conductor is selected from a metal.

17. A lead-through assembly comprising a base having one or more through-openings wherein each of said through-openings has an electrical lead-through of claim 1 arranged therein.

18. (canceled)

19. (canceled)

20. The electrical lead-through of claim 1, wherein the leakage path extension is connected in an integrally bonded manner to the holding portion by glass soldering or adhesive bonding.

21. The electrical lead-through of claim 7, wherein the material of the leakage path extension is a thermoplastic material.

22. The electrical lead-through of claim 11, wherein, with different material selection, the thermal expansion coefficient of the leakage path extension deviates by less than 10% from the thermal expansion coefficient of the holding portion.

23. The electrical lead-through of claim 15, wherein the material of main body is steel.

24. The electrical lead-through of claim 16, wherein the electrical conductor metal is selected from the group consisting of nickel-iron alloys, cobalt-iron alloys, a steel, aluminum, copper or a combination thereof.
